(19) United States
(12) Patent Application Publication
(10) Pub. No.: US 2008/0215092 A1
(43) Pub. Date: Sep. 4, 2008

(54) Pacifier Coupling System

(76) Inventor: Monica Smith, Atlanta, GA (US)

Correspondence Address: TROUTMAN SANDERS LLP, 600 PEACHTREE STREET , NE, ATLANTA, GA, 30308, US

(21) Appl. No.: 12/031,218

(22) Filed: Feb. 14, 2008

Related U.S. Application Data
(60) Provisional application No. 60/889,781, filed on Feb. 14, 2007.

(51) Int. Cl. A61J 17/00

(52) U.S. Cl. 606/236; 606/234

(57) ABSTRACT

A two-piece joint designed to allow a one-piece silicone pacifier to be removably attached to an appealing stuffed toy, soothing blanket, or other article that might be attractive to an infant. One section of the joint includes the back of the pacifier, and the second section of the joint is made as a receiver that accepts the male joint members and permit the pacifier to be semi-permanently attached to the toy.

### CROSS REFERENCE TO RELATED APPLICATION

This application claims benefit under 35 U.S.C. §119(e) of U.S. Provisional Patent Application Ser. No. 60/889,781 filed 14 Feb. 2007, which application is hereby incorporated by reference.

### BACKGROUND OF THE INVENTION

1. Field of the Invention

The present invention relates generally to a pacifier assembly, and in particular to a pacifier coupling system that provides a safe and convenient means to removeably secure a pacifier to an infant article, for example, a stuffed toy. The pacifier coupling system provides convenience, control and weaning assistance to parents whose children use pacifiers.

2. Description of Related Art

Pacifiers and their use are well known. The conventional pacifier has a nipple or teat that an infant accepts in the mouth, an annular ring larger than the mouth to prevent the child from swallowing the pacifier, and a distal projection that allows the child or adult to manipulate the pacifier, mainly serving as the structure for pulling the pacifier out of the child's mouth.

As well, there are known combinations of pacifiers and soothing items. Typical of these is U.S. Pat. No. 4,277,910 to Kramer. Kramer discloses an object or toy, naturally attractive to small children and infants, provided with a receptacle at an advantageous location for reception of a nipple serving as a pacifier. The nipple, in turn, is one suitable for being individually sterilized from time to time The receptacle is therefore provided with a re-closeable clamp, effectively concealed within the toy, but capable of releasably grasping a smoothly contoured projection on one end of the nipple to hold it in position on the toy from which it can be released at will.

U.S. Pat. No. 5,344,355 to Silverstein discloses a stuffed toy (doll or animal) with a flexible extension member and pacifier retaining loop extending off and away from the toy, in the form of a hat or a tail, for attachment and detachment of the pacifier to the doll. The pacifier may then be sterilized and the doll or animal laundered. The pacifier retaining loop is fed through the ring of the pacifier. The end of the pacifier retaining loop that has a snap or hook attached to it, is then fed through a small opening in the back of the extension member. The snap on the end of the pacifier retaining loop snaps onto a receiving snap button that is attached to the inside of the extension member. The parent accesses the inside of the extension member in order to attach or detach the pacifier through a VELCRO lined opening situated in the back of the extension member.

U.S. Pat. No. 5,534,014 to Demeritt et al. discloses a pacifier for satisfying an infant's desire to bite and feed as well as the infant's desire to grasp objects. The device includes an elongated main body formed of a compressible material that the infant can grasp. A pacifier is removably coupled to a side of the main body such that the main body will extend along a center of the torso portion of the infant during the use of the pacifier, whereby the infant can embrace and manipulate the device as desired.

U.S. Pat. No. 5,593,336 to Thomas discloses a pacifier holder for holding a pacifier on its upper surface for easy use by an infant. The pacifier holder includes a soft, light-weight elongated generally tubular member that loosely holds a pacifier on its first or upper end region. The holder is configured such that this first end region is offset by curvature from the remainder of the holder so as to position the pacifier in front of the infant's mouth when in use as the remainder of the elongated holder is placed upon the infant's chest. During use, the holder, being placed on the top of the infant, will be positioned such that the pacifier is in easy reach of the infant.

U.S. Pat. No. 6,666,740 to Schneider discloses a stuffed toy in the shape of a small animal such as a puppy, and is attached to a silicone/polymeric pacifier of the type commonly provided to infants to suck on. The pacifier has at least one tab projecting from the side opposite to the nipple and for use in securing the toy to the pacifier.

As is apparent from the art, many pacifiers are made of multiple components with a flexible nipple and a separate rigid mouth shield, disadvantageously creating a crevice at the point of attachment between the shield and the nipple shaft where dirt and germs can accumulate. What is needed, therefore, is a one-piece design and coupling system that avoids the hygiene issues associated with the prior art multi-piece design. It is to such a system that the present invention is primarily directed.

### BRIEF SUMMARY OF THE INVENTION

Briefly described, in preferred form, the present invention is a pacifier coupling system comprising a pacifier, a coupling element, and an infant article. The coupling element is securedly attached to the infant article, and provides a releasably secured coupling for the pacifier that preferably cannot be activated by the infant.

The pacifier has a teat end and a flange end, and the coupling element has a pacifier face and an article face. A releasably securing assembly is provided to releasably secure the pacifier to the coupling element, wherein the releasably securing assembly preferably comprises cooperative elements of the pacifier and the coupling element, that upon mating via a friction-fit engagement, releasably secures the pacifier to the coupling element. The article face of the coupling element is attached to the infant article, and the pacifier face of the coupling element is external the infant article, and thus capable of releasably securing the pacifier thereto.

The releasably securing assembly preferably comprises a safety mechanism to inhibit detachment of the pacifier from the coupling element by an infant user of the system, while enabling the detachment of the pacifier from the coupling element by an adult user of the system.

The coupling element is configured to securedly but removeably retain the pacifier, preferably via a friction-fit ball-and-socket configuration. The ball-and-socket are made of deformable materials, thus enabling a “snap” fit of the ball into the socket. Preferably, two or more ball-and-socket intersections are provided for attachment of the pacifier to the coupling element, and one of these intersections is preferably formed in a child-safety/child-proof configuration. In such manner, the pacifier can be removed from the infant article for cleaning of both the pacifier and the infant article, but is intended to be too difficult to release by the baby or child.

The coupling element is secured to the infant article, preferably proximate the rear of the “head” of the infant article, where easy manipulation of the pacifier and hugging of the infant article can occur at the same time, as desired by the child. The coupling element need not be permanently attached to the infant article, as upon weaning, the infant article can be a stand alone article for the child, without a pacifier and/or coupling element attached thereto.

Pacifiers of rubber-like material are common, and such objects that are designed to go in the child's mouth get dirty from being dropped. Consequently, they need to be cleaned and sanitized. The present system allows the user to periodically separate the infant article from the pacifier, sterilize the pacifier, launder the infant article, and then reattach the pacifier to the infant article. The present pacifier coupling system prevents the pacifier from being damaged and dirtied as easily as known combinations, but still allows the pacifier to be easily removed by a parent for sterilization.

The present invention provides a safe and releasably secured coupling between the pacifier and the infant article, allowing the child to become attached to the infant article while using the pacifier. At the time of desired weaning from the pacifier, the infant article will remain unaltered to allow for continued emotional satisfaction further into childhood.

Thus, the present invention improves the infant's coordination and dexterity because the child learns how to manipulate the pacifier in and out of his/her own mouth, and it enables a younger child to independently keep his/her pacifier in their own mouth by providing a larger object (infant article) to hold at a more comfortable level than the mouth. It thus results in fewer dropped pacifiers leading to more sanitary conditions for the pacifier itself; however, at times when it is deemed necessary, the coupling system allows the components to be properly sanitized and then reattached.

These and other objects, features and advantages of the present invention will become more apparent upon reading the following specification in conjunction with the accompanying drawings.

### BRIEF DESCRIPTION OF THE FIGURES

FIG. 1 illustrates a perspective view of the present system according to a preferred embodiment.

FIG. 2 illustrates a perspective view of the pacifier of the present invention according to a preferred embodiment.

FIG. 3 illustrates another perspective view of the pacifier of FIG. 2.

FIG. 4 illustrates a perspective view of the coupling element of the present invention according to a preferred embodiment.

FIG. 5 illustrates another perspective view of the coupling element of FIG. 4.

FIG. 6 illustrates a perspective view of the pacifier releasably secured to the coupling element of the present invention according to a preferred embodiment.

FIG. 7 illustrates another perspective view of the pacifier and coupling element of FIG. 6.

### DETAILED DESCRIPTION OF PREFERRED EMBODIMENTS

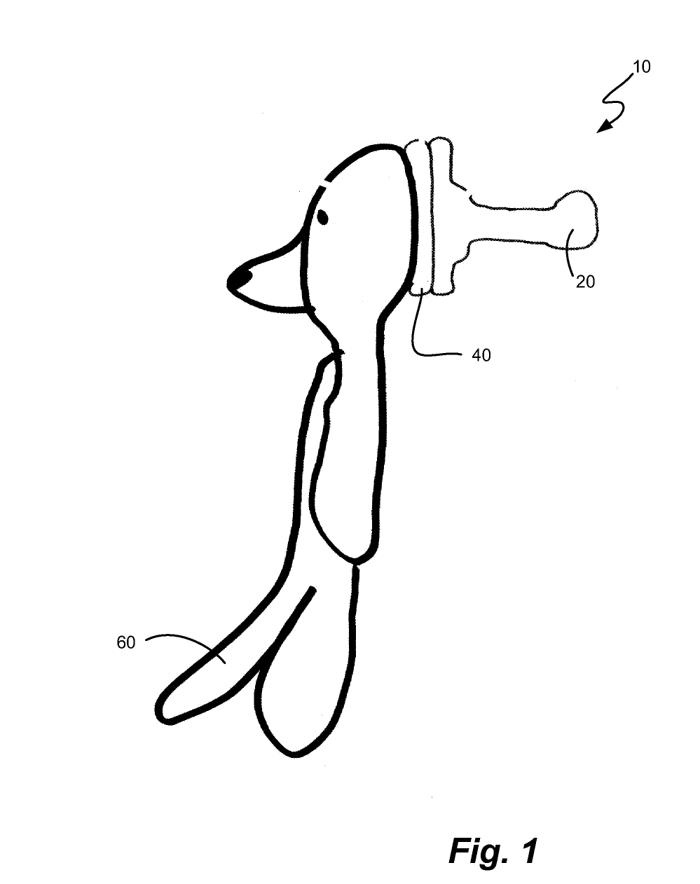

Referring now in detail to the drawing figures, wherein like reference numerals represent like parts throughout the several views, the present invention of FIG. 1 provides a pacifier coupling system 10 comprising a pacifier 20, a coupling element 40, and an infant article 60.

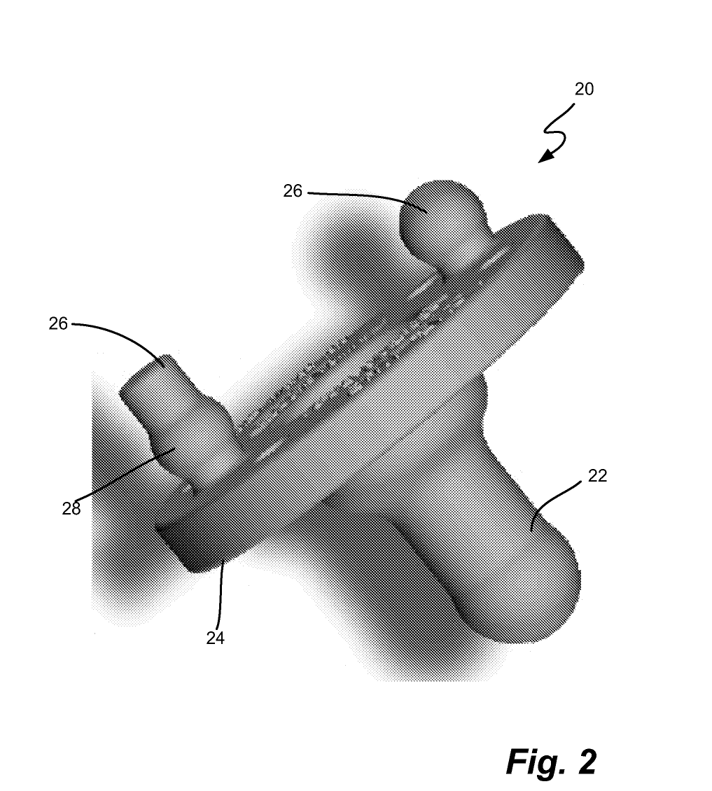

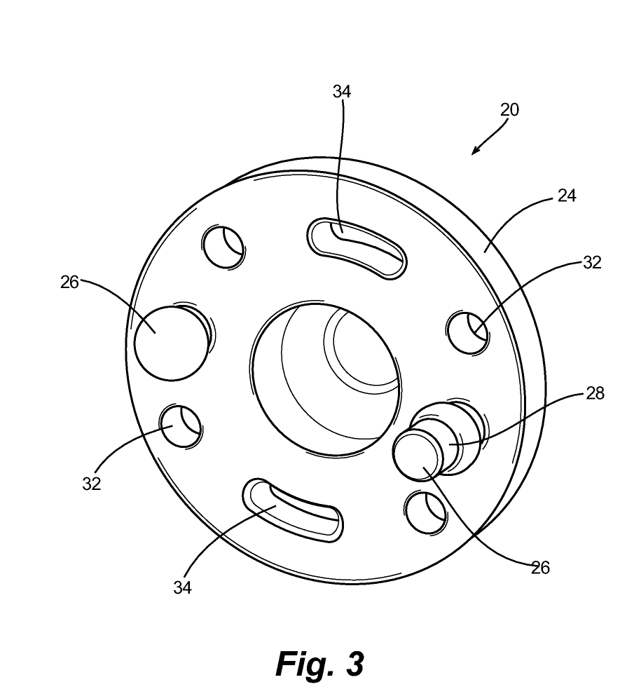

As shown in FIGS. 2 and 3, the pacifier 20 is preferably of one-piece construction. The pacifier 20 includes a pacifier teat 22, and a pacifier flange 24. The pacifier 20 can be formed of a molded polymeric material, preferably containing silicone. It can also be an over-molded style that utilizes a rigid component for the flange 24 that is over-molded with an elastomeric material so that the finished product is still virtually one-piece in nature. Many pacifiers are made of multiple components with a flexible nipple and a separate rigid mouth shield creating a crevice at the point of attachment between the shield and the nipple shaft where dirt and germs can accumulate. The present one-piece pacifier 20 avoids the hygiene issues associated with the multi-piece design.

The pacifier's teat 22 can either be round with an expanded head as shown, or be of the orthodontic-style of nipple. It can be sized for use for full term infants, or sized for premature infants. The flange 24 is preferably shaped as an annular ring, which design beneficially prevents the child from swallowing the pacifier 20.

On the distal side of the flange 24 are one or more pacifier securing elements 26 designed to cooperatively engage the coupling element 40 of the system 10. In one preferred embodiment, the pacifier securing elements 26 are male members extending from the flange 24, and they present a friction-fit engagement with the coupling element 40.

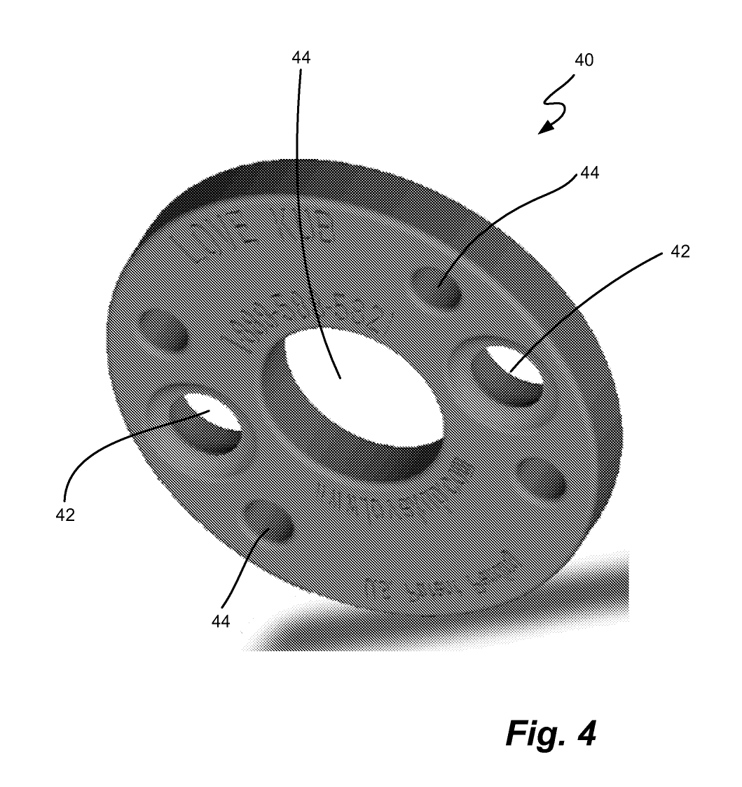

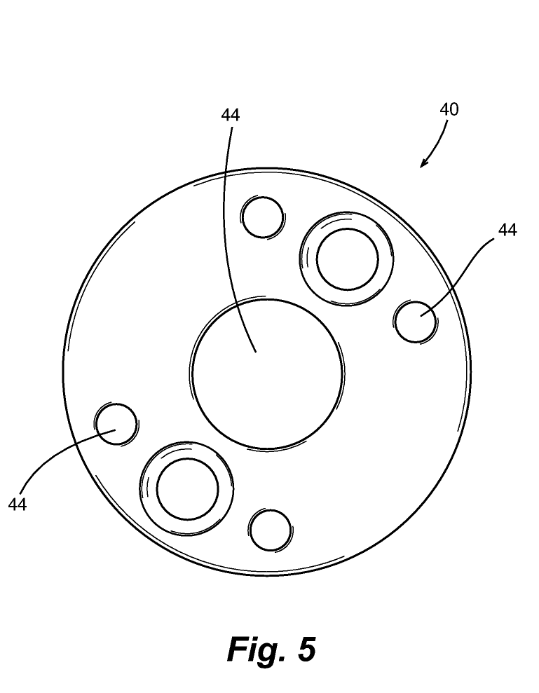

As shown in FIGS. 4 and 5, the coupling element 40 preferably is also of one-piece construction. The coupling element 40 can be formed of a molded of a polymeric material containing silicone; however, the coupling element 40 can also be of over-molded construction. The coupling element 40 comprises one or more coupling securing elements 42 designed to cooperatively engage the pacifier securing elements 26. In one preferred embodiment, the coupling securing elements 42 are female members of the coupling element 40.

The infant article 60 is preferably a stuffed toy, blanket or other attractive article for infant. As shown in FIG. 1, the infant article 60 is a stuffed toy being essentially a deformable fabric envelope with filling that expands the toy to a three dimensional shape with specific configuration that includes a central axis with at least two appendages of length significant enough to allow manipulation of the pacifier by holding and moving the appendages. A typical stuffed toy of this type is very soft to the touch as well as pliable enough to deform in the hands of a small child. The stuffed toy also has a head projection.

The coupling element 40 is preferably attached (sewn or through the use of adhesive) to the infant article 60, or can be integral to the infant article's design.

Thus described, the present invention 10 relates to a system of attachment of the pacifier 20 to the infant article 60, preferably an infant soothing object. The preferred two-piece coupling system 10 comprises a one-piece pacifier 20 with male or female elements built into the back of the flange 24, and a separate coupling element 40 that contains complimentary matches 42 of the male or female elements of the pacifier 20. The coupling element 40 is made to be sewn onto or into the infant article 60.

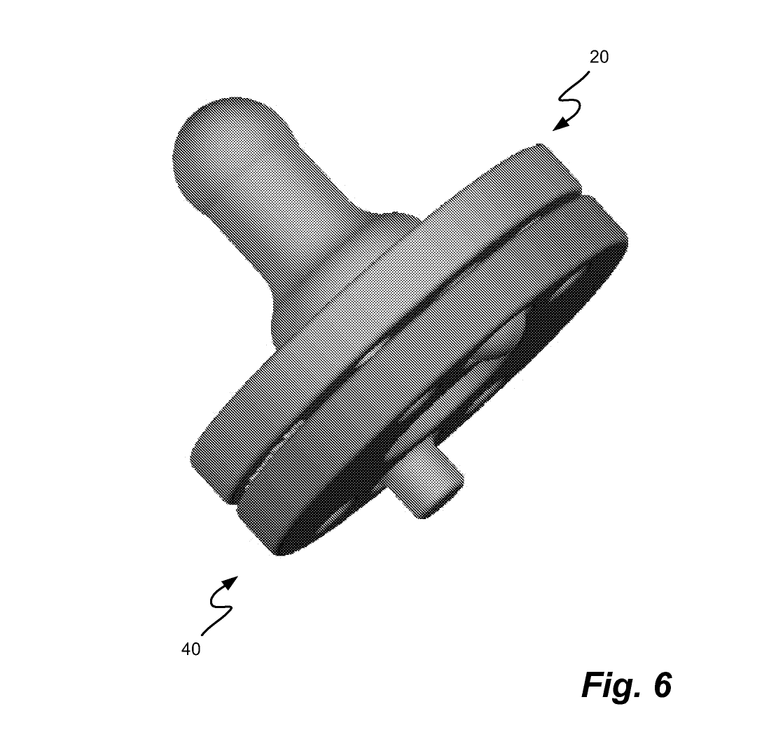

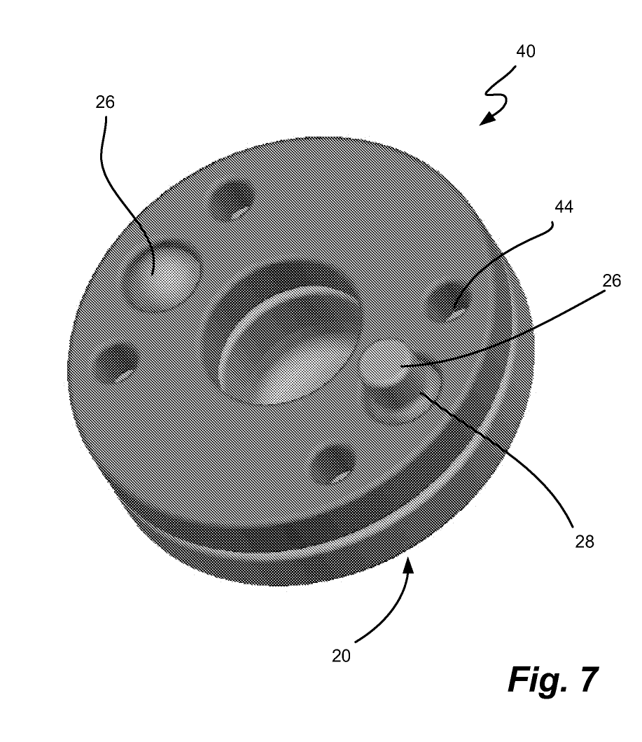

As shown in FIGS. 6 and 7, in a preferred embodiment, the releasable securement between pacifier 20 and coupling element 40 is of the ball-and-socket style, which relies upon a friction-fit between the two parts that is sufficient to prevent the infant or child from separating the two parts, but that allows it to be separated by an adult. Other embodiments of the releasable securement include a screw style joint, a barb-style of attachment, as well as one that would replicate the physics of a snap-on lid.

The relative positioning of the coupling element 40 on the infant article 60 is significant, since proper placement allows the pacifier 20 to be manipulated indirectly when the child grossly adjusts, for example, the stuffed toy. It is preferred that the pacifier 20 not be placed on the tip of any appendage, because this would lead to a floppy pacifier, and provide a disadvantageous system. Rather, by attaching it flushingly to an appendage of comparable size to the coupling element 40, the child is able to independently manipulate, hold the teat 22 of the pacifier 20 in his/her mouth securely, hug the article 60 to his/her body concomitantly, or position the pacifier 20 in the infant's mouth.

The Figs. illustrate the present system 10, wherein the infant article 60 is a stuffed toy for exemplary purposes only. The coupling element 40 is shown with two coupling securing elements 42, being female receiver sockets that allow the pacifier 20 to snappingly engage the pacifier securing elements 26, being male ball prongs. As shown, one of the prongs 28 is adapted to act as a safety mechanism designed to allow manipulation and removal of the pacifier 20 by the adult. Air holes 32, 44 can be provided on one or both the pacifier 20 and coupling element 40 such that if the pacifier 20 and/or coupling element 40 are ingested or otherwise caught in the airway of the child, air can still move through the system 10 to allow for respiration until they can be removed. Further, the pacifier 20 can be provided with one or more apertures 34 to allow attachment by a clothing clip for use as the child gets older.

Numerous other embodiments can be used to releasably couple the pacifier 20 to the coupling element 40. For example, one of the pacifier 20 or coupling element 40 can incorporate one or more flanges that cooperate with the other of the pacifier 20 or coupling element 40 that contains one or more complimentary lips, whereupon the flanges are pushed under the lips, and with a relative twisting motion between the pacifier 20 and coupling element 40, the flanges move under and are secured by the lips, with disengagement generally had by reversing this action. In another embodiment, one or more extended portions extending from one of the pacifier 20 or coupling element 40 can fit within one or more corresponding apertures of the other of the pacifier 20 or coupling element 40, wherein such aperture(s) have two portions, a large portion that is oversized to accept the extended portion, and a small portion that tightly fits the extended portion. In another embodiment, the pacifier 20 and coupling element 40 are releasably secured to one another via magnetic attraction, either alone, or in combination with one or more of the above connection options. In another embodiment, the pacifier 20 and coupling element 40 are releasably secured to one another via hook and loop fasteners, either alone, or in combination with one or more of the above connection options.

While a particular embodiment of the invention has been shown and described, various modifications thereof will be apparent to those skilled in the art of joint making, and therefore it is not intended that the invention be limited to the disclosed embodiment or to the details thereof and departures may be made there from with in the spirit and scope of the invention defined in the claims.

What is claimed is:

1. A pacifier coupling system comprising:
a pacifier with a teat end and a flange end;
a coupling element have a pacifier face, and an article face; and
a releasably securing assembly to releasably secure the pacifier to the coupling element.

2. The pacifier coupling system of claim 1, wherein the releasably securing assembly comprises cooperative elements of the pacifier and the coupling element, that upon mating, releasably secure the pacifier to the coupling element.

3. The pacifier coupling system of claim 2, wherein the releasably securing assembly is a ball-and-socket configuration.

4. The pacifier coupling system of claim 2, wherein the releasably securing assembly is a screw-style joint configuration.

5. The pacifier coupling system of claim 2, wherein the releasably securing assembly is a barb-style configuration.

6. The pacifier coupling system of claim 2, wherein the flange end of the pacifier has one or more male members extending therefrom, and wherein the coupling element has one or more apertures to accept the one or more male members of the flange end of the pacifier via a friction-fit engagement.

7. The pacifier coupling system of claim 1, further comprising an infant article, wherein the article face of the coupling element is attached to the infant article, and wherein the pacifier face of the coupling element is capable of releasably securing the pacifier thereto.

8. The pacifier coupling system of claim 7, the infant article comprising a stuffed animal.

9. A pacifier coupling system comprising:
a one-piece pacifier with a teat end and a flange end;
a one-piece coupling element; and
a releasably securing assembly to releasably secure the pacifier to the coupling element;
wherein the releasably securing assembly comprises a safety mechanism to inhibit detachment of the pacifier from the coupling element by an infant user of the system, while enabling the detachment of the pacifier from the coupling element by an adult user of the system.

10. The pacifier coupling system of claim 9, wherein the releasably securing assembly comprises cooperative elements of the pacifier and the coupling element, that upon mating, releasably secure the pacifier to the coupling element.

11. The pacifier coupling system of claim 10, wherein the releasably securing assembly is a ball-and-socket configuration.

12. The pacifier coupling system of claim 9, further comprising an infant article, wherein the article face of the coupling element is attached to the infant article, and wherein the pacifier face of the coupling element is capable of releasably securing the pacifier thereto.

13. The pacifier coupling system of claim 12, the infant article comprising a stuffed animal.
